(19) United States
(12) Patent Application Publication
(10) Pub. No.: US 2024/0405715 A1
(43) Pub. Date: Dec. 5, 2024

(54) NANOGAP THERMOPHOTOVOLTAICS ENABLED BY CONTROLLED DEPOSITION AND ETCHING

(71) Applicant: Alliance for Sustainable Energy, LLC, Golden, CO (US)

(72) Inventors: Jennifer Grace SELVIDGE, Wheat Ridgge, CO (US); Ryan Matthew FRANCE, Golden, CO (US); Myles Aaron STEINER, Denver, CO (US); Eric James TERVO, Madison, WI (US)

(21) Appl. No.: 18/732,542

(22) Filed: Jun. 3, 2024

Related U.S. Application Data
(60) Provisional application No. 63/505,855, filed on Jun. 2, 2023.

(51) Int. Cl. H02S 10/30

(52) U.S. Cl. CPC H02S 10/30

(57) ABSTRACT

The present disclosure relates to a thermophotovoltaic (TPV) device that includes an emitter having a platform and a base, a block having a photovoltaic (PV) cell, and three posts, where the platform includes a first surface having a first surface area between 0.1 cm² and 1,000 cm², the PV cell includes a second surface having a second surface area between 0.1 cm² and 1,000 cm², the posts separate the first surface from the second surface by a space in the y-axis direction between 1 nm and 1,000 nm, each post is paired with a gap that separates the post from the platform, each gap is between 0.5 μm and 500 μm in the x-axis direction, and the TPV device is capable of converting at least one of near-infrared light or mid-infrared light to electricity.

### CROSS-REFERENCE TO RELATED APPLICATIONS

This application claims priority from U.S. Provisional Patent Application No. 63/505,855 filed on Jun. 2, 2023, the contents of which are incorporated herein by reference in the entirety.

### CONTRACTUAL ORIGIN

This invention was made with government support under Contract No. DE-AC36-08GO28308 awarded by the Department of Energy. The government has certain rights in the invention.

### BACKGROUND

For thermophotovoltaics, devices that convert near-IR radiation (between 0.7 μm and 2.5 μm) to mid-IR radiation (between >2.6 μm and 25 μm) into electricity, creating a nanoscale (10 s-100 s of nm) gap between the hot emitter and the cool cell is of great technological importance. At this distance, referred to as near-field, additional heat transfer pathways associated with photon tunneling become active between the emitter and the cell. Prior work in this area has focused on small footprint devices that pose scalability challenges, large area gaps defined by nanospheres which suffer from significant parasitic conduction losses, and large area devices relying on extremely challenging nanofabrication processes. Thus, there remains a need for methods of manufacturing large area devices having a constant nanogap between the emitter and the photovoltaic cell.

### SUMMARY

An aspect of the present disclosure is a thermophotovoltaic (TPV) device that includes an emitter having a platform and a base, a block having a photovoltaic (PV) cell, and three posts, where the platform includes a first surface having a first surface area between 0.1 cm² and 1,000 cm², the PV cell includes a second surface having a second surface area between 0.1 cm² and 1,000 cm², the posts separate the first surface from the second surface by a space in the y-axis direction between 1 nm and 1,000 nm, each post is paired with a gap that separates the post from the platform, each gap is between 0.5 μm and 500 μm in the x-axis direction, and the TPV device is capable of converting at least one of near-infrared light or mid-infrared light to electricity.

In some embodiments of the present disclosure, each post may have a height in the y-axis direction between 1 μm and 100 μm or between 10 μm and 50 μm. In some embodiments of the present disclosure, each post may have a length dimension in the x-axis direction between 1 μm and 250 μm or between 10 μm and 100 μm. In some embodiments of the present disclosure, each post may include a column and tab, where each column is positioned between tab and the base, and the tab has thickness in the y-axis direction that is about equal to the space.

In some embodiments of the present disclosure, the emitter may be configured to operate at a first temperature between 100° C. and 2500° C. In some embodiments of the present disclosure, the first temperature may be between 200° C. and 600° C. In some embodiments of the present disclosure, the block may be configured to operate at a second temperature between −200° C. and 500° C.

In some embodiments of the present disclosure, the PV cell may be constructed of a semiconductor having bandgap between 0.1 eV and 2.0 eV. In some embodiments of the present disclosure, the PV cell may be constructed using a first III-V alloy. In some embodiments of the present disclosure, the first III-V alloy may include InAs. In some embodiments of the present disclosure, the emitter may be constructed of a second III-V alloy. In some embodiments of the present disclosure, the platform, the base, and each post may be constructed of the second III-V alloy. In some embodiments of the present disclosure, the second III-V alloy may include at least one of GaAs, InP, InAs, and/or GaSb. In some embodiments of the present disclosure, the platform, the base, and each column may each be constructed of a second III-V alloy, and each tab may be constructed of a third III-V alloy. In some embodiments of the present disclosure, the second III-V alloy may include at least one of GaAs, InP, InAs, and/or GaSb, and the third III-V alloy may include GaInP.

In some embodiments of the present disclosure, the posts may be positioned directly on the second surface. In some embodiments of the present disclosure, the block may further include a substrate, and the PV cell may be positioned on the substrate. In some embodiments of the present disclosure, the posts may be positioned directly on the substrate.

In some embodiments of the present disclosure, the TPV device may further include a front contact that includes a grid positioned on the second surface of the PV cell, where the grid is positioned in the space without physically touching the first surface of the emitter. In some embodiments of the present disclosure, the TPV may further include a trench formed in the first surface of the emitter, where the grid is positioned within the trench such that the grid does not physically contact the first surface of the emitter. In some embodiments of the present disclosure, the TPV device may further include a via passing through at least one of the PV cell or the substrate, where the outer circumference of the via is lined with an insulator, and the remainder of the via is at least partially filed with an electrical connection connected to the grid.

An aspect of the present disclosure is a method for fabricating a thermophotovoltaic device, where the method includes: depositing a conformal layer having a surface and a first thickness and comprising a first III-V alloy onto a surface of a substrate having a second thickness and comprising a second III-V alloy; depositing a first mask onto a first section, a second section, and a third section of the surface of the conformal layer, resulting in three portions of the surface of the conformal layer being covered by the first mask, separated by at least two portions of the surface of the conformal layer not covered by the first mask; selectively removing the at least two portions of the conformal layer not covered by the mask, resulting in the conformal layer being divided into a platform positioned between a first tab and a second tab, with a first gap positioned between the first tab and the platform, and a second gap positioned between the second tab and the platform, where the surface of the substrate is exposed at the first gap and the second gap; selectively removing a portion of the second thickness positioned under the exposed surfaces of the substrate, resulting in the forming of a first post comprising the first tab positioned on a first column of the second III-V alloy having a third thickness, a second post comprising the second tab positioned on a second column of the second III-V alloy having the third thickness, where the platform is positioned between the first post and the second post and each of the first gap and the second gap has a depth equal to the sum of the first thickness and the third thickness; covering each of the first post and the second post with a second mask, while leaving the platform exposed; selectively removing substantially all of the first III-V alloy from the platform resulting in the platform having an exposed surface of the second III-V alloy, and each post capped with the tabs of the first III-V alloy; removing any remaining first mask, second mask, or impurities; depositing a grid onto the exposed surface of the platform, and positioning a block having a surface and comprising a third III-V alloy parallel to and adjacent to the exposed surface of the platform, resulting in a uniform space positioned between the surface of the block and the exposed surface of the platform, where the surface of the block only has direct physical contact with the tabs.

An aspect of the present disclosure is a method for fabricating a thermophotovoltaic (TPV) device, where the method includes: depositing an oxide mask onto a first surface of a layer comprising a III-V alloy resulting in a first portion of the first surface that is masked and a second portion of the first surface that is not masked; selectively removing a some of the layer corresponding to the second portion of the first surface, resulting in the forming of a gap defined by a column and a platform comprising a second surface and a thickness; removing the oxide mask; treating the second surface of the platform using ion implantation resulting in a converting of a portion of the thickness to a doped III-V alloy; selectively removing at least a portion of the doped III-V alloy, resulting in the platform having a height in the y-axis direction that is less than a height of the column in the y-axis direction; and placing a PV cell onto the column resulting in the TPV device.

### BRIEF DESCRIPTION OF DRAWINGS

Some embodiments are illustrated in referenced figures of the drawings. It is intended that the embodiments and figures disclosed herein are to be considered illustrative rather than limiting.

FIGS. 1A-1C illustrate a thermophotovoltaic (TPV) device, according to some embodiments of the present disclosure.

FIG. 2 illustrates (Panel A) a grid positioned on block and a space created by positioned an emitter on the block and (Panel B) a column constructed of a column and a tab, according to some embodiments of the present disclosure.

FIG. 3A illustrates an exemplary TPV device, where the emitter is modified to include trenches designed to contain the grid positioned on the block, according to some embodiments of the present disclosure.

FIG. 3B illustrates an example of a metal grid positioned in a trench formed in an emitter, as well as a via formed through the thickness of the block, to simplify the wiring connections for the grid, according to some embodiments of the present disclosure.

FIG. 4 illustrates a method for manufacturing TPV devices, according to some embodiments of the present disclosure.

FIGS. 5A and 5B illustrate the intermediate devices resulting from the method steps shown in FIG. 4, according to some embodiments of the present disclosure.

FIG. 6 illustrates an alternative method for manufacturing TPV devices, involving ion implantation, according to some embodiments of the present disclosure.

FIG. 7 illustrates a method for manufacturing TPV devise, similar to that illustrated in FIGS. 4-5B, according to some embodiments of the present disclosure.

FIG. 8 illustrates a dark current (JD)-voltage curve for a TPV device described herein showing a reverse bias saturation current of approximately 20 mA cm-2, according to some embodiments of the present disclosure. The inset presents a schematic of the full PV cell structure.

FIG. 9 illustrates an SEM image of an emitter and cell pair fabricated using the methods described herein, with a 600 (±50) nm space, according to some embodiments of the present disclosure.

FIG. 10 illustrates various embodiments of the present disclosure: a) Schematic of NFTPV test set-up. Current-voltage behavior at various emitter temperatures for the cell in b) near-field and c) far-field configurations (note the difference in scale on the current axes). d) Comparison of the measured short circuit current density as a function of emitter temperature in the near- and far-field configurations and theoretical photocurrents assuming an internal quantum efficiency of 100% or 15% (dashed lines). The measured near-field data exceed theoretical far-field limit. e) Comparison of generated power at the maximum power point as a function of emitter temperature in the near- and far-field cases, demonstrating more than an order of magnitude improvement in the near-field case. f) Open circuit voltage as a function of short circuit current density in the two cases, suggesting cell heating in the near-field case.

FIG. 11 illustrates various embodiments of the present disclosure: a) Modeled J-V curves assuming a standard two-diode model and a three-diode model, including an Auger specific dark current as a function of cell temperature and measured J-V with a 460° C. With a non-zero series resistance, both open circuit voltage and short circuit current density magnitude decrease with increasing temperature. b) Modeled Power Density at maximum power point as a function of temperature assuming various cell and device improvements.

### REFERENCE NUMERALS

100 thermophotovoltaic device
110 block
113 substrate
114 photovoltaic (PV) cell
115 surface of the PV cell
120 emitter
123 base
125 platform
127 surface of the platform
130 post
135 tab
137 column
140 space (y)
150 gap (x)
160 grid
300 method
310 first depositing
312 base layer
314 conformal layer
320 second depositing
322 first mask
330 first removing
340 second removing
350 third depositing
352 second mask
360 third removing
370 fourth removing
380 positioning of block

### DETAILED DESCRIPTION

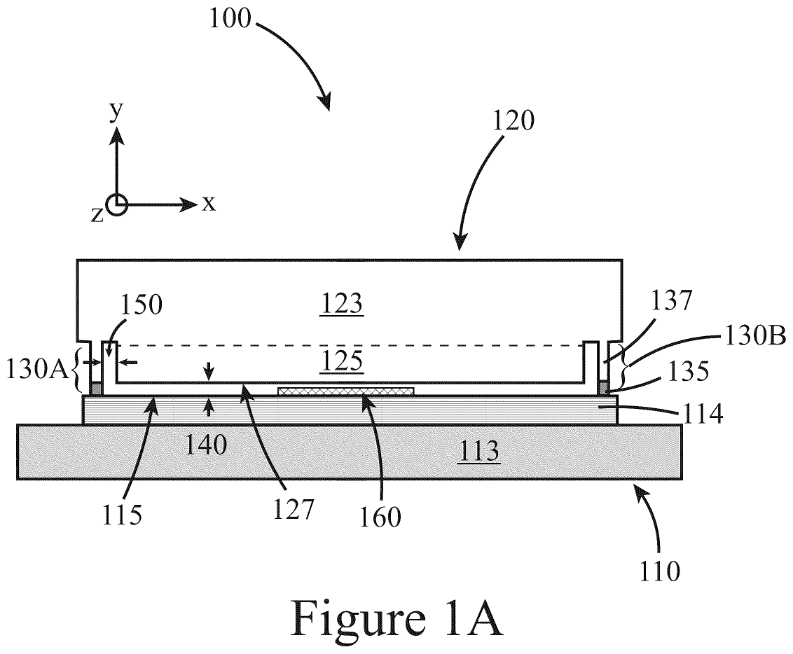

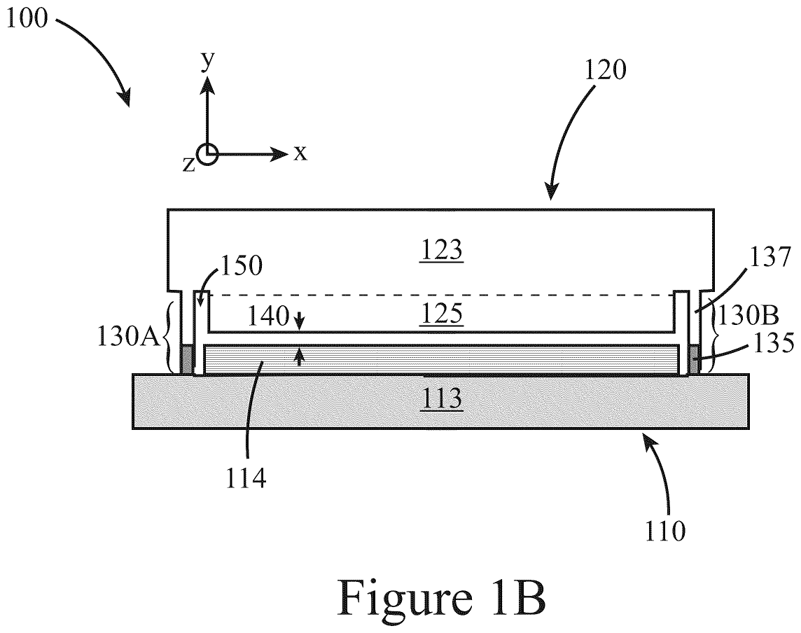

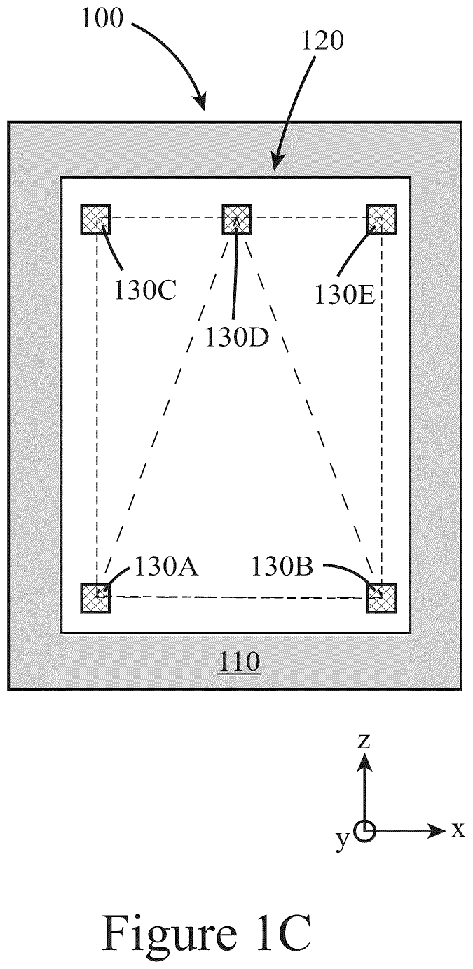

The present disclosure relates to near-field thermophotovoltaic (TPV) devices and to methods for manufacturing TPV devices, including methods for manufacturing emitters. As shown herein, manufacturing methods may use epitaxy and/or other deposition techniques and/or other techniques, resulting in TPV devices characterized by low thickness variations in the emitters over large surface areas. Further, selective etching was successfully utilized to define, among other things, a narrow space between the emitter and thermophotovoltaic cell, where the space can be either filled with a gas or the gas may be evacuated (e.g., the space may be under vacuum). FIG. 1A illustrates a two-dimensional (2D) schematic (in the xy-plane; x=width (W); y=height (H)) of a TPV device 100, according to some embodiments of the present disclosure. A 2D schematic is shown for illustrative purposes, and an actual TPV device 100 is a three-dimensional (3D) object, with a third dimension in the z-axis direction corresponding to depth (D), the details of which are described below.

A TPV device 100 has two main components, an emitter 120 and a block 110 that includes a photovoltaic (PV) cell 114 positioned on a substrate 113, and/or a handle. A substrate 113 may be constructed of a relatively inexpensive material onto which the PV cell 114 may be deposited. A PV cell 114 may be a single junction cell, a two-junction device, or a multi-junction device. An emitter 120 may have two portions, a platform 125 and a base 123, where the platform 125 contains a surface 127 positioned adjacent to a surface 115 of the PV cell 114, creating a space 140. The emitter 120 may be operated at an elevated temperature, T_{H}, e.g., between 100° C. and 2500° C. or between 200° C. and 600° C., whereas the block 110 may be operated at a significantly lower temperature, T_{c}, e.g., between −200° C. and 500° C. or between 20° C. and 50° C. Without elaborating on theory, the temperature difference, ΔT, between the operating temperature of the hot emitter 120 and the relatively cold temperature of the block 110, ΔT=T_{H}−T_{C}, provides the driving force for heat transfer from the emitter 120 to the block 110. In some embodiments of the present disclosure, ΔT may be between 20° C. and 1500° C. An emitter 120 may be heated by a variety of means known in the art such as electrical resistive heating, exposure to hot combustion products, absorption of solar radiation, and/or other methods. A block 110 may be cooled by a variety of means known in the art such as contact with a Peltier (thermoelectric) cooler, contact with a liquid-cooled heat sink, and/or other methods.

The amount of power generated by a TPV device 100 is proportional to the surface area available for heat transfer between the emitter 120 to the block 110. It is, therefore, desirable to maximize the surface areas of the opposing faces of the emitter 120 and the PV cell 114 of the block 110, with each surface in view of the other. Further, to take advantage of near-field modes of heat transfer, it is desirable to place the two surfaces (115 and 127) adjacent and substantially parallel to one another and as close as possible. Thus, referring again to FIG. 1A, each of the platform 125 of the emitter 120 and the PV cell 114 have a surface, 127 and 115, respectively, which are positioned parallel and adjacent to one another, forming a narrow space 140 as measured in the y-axis direction between the two surfaces (115 and 127). It is preferred that this space 140 be as small as possible so as to take advantage of evanescent heat transfer modes, i.e., near-field heat transfer. In some embodiments of the present disclosure, a space 140 between two parallel surfaces (127 and 115) may be between 1 nm and 1,000 nm or between 10 nm and 200 nm or between 50 nm and 100 nm.

Referring again to FIG. 1A, in this embodiment of the disclosure, the emitter 120 is placed directly onto the surface 115 of the PV cell 114 of the block 110. Both posts 130A and 130B are placed directly onto the surface 115 of the PV cell 114. By doing so, the accuracy of obtaining the desired space 140 between the surface 127 of the platform 125 and the surface of the PV cell 114 is increased. FIG. 1B illustrates another example of a TPV device 100, according to some embodiments of the present disclosure. In this example, the posts (130A and 130B) of the emitter 120 are positioned on the substrate 113 of the block 110. This embodiment has its own advantages including electrical isolation of the PV cell 114 from the emitter 120 and potentially reducing conductive heat transfer to the cell 114. However, this design also adds another variable that can affect the accuracy of the space 140; now the space is determined by variability in the height of the tabs 135 and the height of the PV cell 114 (both in the y-axis direction).

A space 140 between the surface 127 of an emitter's 120 platform 125 and the surface 115 of a PV cell 114 is both created (see description of methods of manufacture below) and maintained by at least three posts 130, each constructed of a tab 135 positioned on a column 137. Referring again to FIG. 1A, two posts 130 are shown positioned within the xy-plane of the 2D schematic. FIG. 1C illustrates a 2D schematic of the TPV device 100 from a different perspective to illustrate possible locations of posts 130 in the xz-plane. To maintain an even space 140 across the entire xz-plane, a minimum of three posts 130 are needed. A three-post embodiment may be, for example, the combination of posts 130A, 130B, and 130D, positioned in a triangular configuration. In some embodiments of the present disclosure, a space 140 between the surface 127 of an emitter's 120 platform 125 and the surface 115 of a PV cell 114 may be maintained using four posts (130A, 130B, 130C, and 130E), positioned in an approximately square configuration or rectangular configuration. The exact position of posts 130, and whether three or four posts or more are used, may depend on the specific dimensions and surface areas of the platform 125 and the block 110 and/or PV cell 114. In some embodiments of the present disclosure, a post 130 may be positioned at a maximum allowable distance from neighboring posts 130, for example at or near the extreme edges of an emitter 120, as measured in the x-axis direction and/or in the z-axis direction; e.g., when using a square configuration or rectangular configuration. In some embodiments of the present disclosure, a post 130 may be positioned at the midpoint of an emitter 120, as measured in the x-axis direction and/or in the z-axis direction; e.g., when using a triangular configuration. The number of posts 130 used may depend on, among other things, the sizes (e.g., surface areas) of the emitter 120 and the platform 125. Larger surface areas may result in the use of more posts 130. In some embodiments of the present disclosure, a TPV device 100 may utilize an array of posts 130; e.g., a 2×2 array, a 3×3 array, an n×n array of posts, where n may be between 2 and 10, inclusively.

Further, the cross-sectional shape of a post 130, shown as a square in FIG. 1C may be a variety of other shapes, including circular, elliptical, rectangular, etc. In some embodiments of the present disclosure, the height (Hₚ) of a post 130 in the y-axis direction, including both the column 137 and the tab 135 may be between 1 μm and 100 μm or between 10 μm and 50 μm. As described below, a space 140 may be at least partially defined by the height (in the y-axis direction) of the tabs 135 used in the posts 130. Therefore, in some embodiments of the present disclosure, a tab 135 may have a height (Hₜ) between 1 nm and 1000 nm or between 10 nm and 200 nm or between 50 nm and 100 nm. As a result, the height of a column 137 (in the y-axis direction), He, is the difference between the height of a post 130 and its tab 135 (H_{c}=Hₚ−Hₜ). In some embodiments of the present disclosure, the width, radius, and/or diameter of a post 130 in the x-axis direction, for both the column 137 and the tab 135 may be between 1 μm and 250 μm or between 10 μm and 100 μm. In general, the height of a post 130, Hₚ, is maximized to minimize conductive heat transfer from the hot emitter 120 to the relatively cold block 110, while still maintaining structural integrity of post 130. Depending on the method of making the posts 130, the width, radius, and/or diameter of a tab 135 may be approximately the same as the width, radius, and/or diameter of a column 137. In some embodiments of the present disclosure, the width, radius, and/or diameter of a tab 135 may be greater than or less than the width, radius, and/or diameter of a column 137.

Referring again to FIG. 1A, as described in more detail below, posts 130 may be formed by patterning and selective etching resulting in the forming of gaps 150 that minimize the physical and thermal connectivity of the posts 130 from the rest of the emitter 120, for example the emitter's platform 125, which is maintained at elevated temperatures to enable heat transfer from the emitter 120 to the block 110. In some embodiments of the present disclosure, a gap 150 between a post 130 and an emitter's platform 125 (in the x-axis direction) may be between 0.5 μm and 500 μm or between 1 μm and 250 μm or between 1 μm and 100 μm.

Referring again to FIG. 1A, it is desirable that the surface 115 of the PV cell 114 and the surface 127 of the platform 125 be as large as reasonably possible. In some embodiments of the present disclosure, a surface 127 of a platform 125 and/or emitter 120 may be between 0.1 cm² and 1,000 cm² or between 1 cm² and 100 cm². In some embodiments of the present disclosure, a surface 115 of an PV cell 114 and/or block 110 may be between 0.1 cm² and 1,000 cm² or between 1 cm² and 100 cm². In some embodiments of the present disclosure, the width (in the x-axis direction) of a PV cell 114 and/or block 110 may be between 0.1 cm and 100 cm or between 1 cm and 10 cm. In some embodiments of the present disclosure, the depth (in the z-axis direction) of a block 110 and/or PV cell 114 may be between 0.1 cm and 100 cm or between 1 cm and 10 cm. In some embodiments of the present disclosure, the height (in the y-axis direction) of a block 110 may be between 10 μm and 1,000 μm or between 100 μm and 750 μm. In some embodiments of the present disclosure, the height (in the y-axis direction) of a substrate 113 of a block 110 may be between 10 μm and 1,000 μm or between 100 μm and 750 μm. In some embodiments of the present disclosure, the height (in the y-axis direction) of a PV cell 114 of a block 110 may be between 10 μm and 1,000 μm or between 100 μm and 750 μm. In some embodiments of the present disclosure, a substrate 113 may be constructed of a metal, e.g., aluminum. In some embodiments of the present disclosure, the width (in the x-axis direction) of an emitter 120 and/or platform 125 may be between 0.1 cm and 100 cm or between 1 cm and 10 cm. In some embodiments of the present disclosure, the depth (in the z-axis direction) of an emitter 120 and/or platform 125 may be between 0.1 cm and 100 cm or between 1 cm and 10 cm. In some embodiments of the present disclosure, the total height (in the y-axis direction) of an emitter 120 may be between 10 μm and 1,000 μm or between 100 μm and 750 μm. Referring again to FIG. 1A, the height of a platform 125 (in the y-axis direction) may be approximately equal to the height of a post's column 137, He. Therefore, the height of an emitter's base 123, may be equal to the total height of the emitter 120 minus the height of the platform 125.

In some embodiments of the present disclosure, an emitter 120 may be constructed of a III-V alloy that includes at least one Group III element and at least one Group V element. Group III elements include boron, aluminum, gallium, indium, and thallium. Group V elements include nitrogen, phosphorus, arsenic, antimony, and bismuth. In some embodiments of the present disclosure, an emitter 120 may be constructed using a Group III-V alloy of at least one of GaAs, InP, InAs, and/or GaSb. In some embodiments of the present disclosure, a PV cell 114 may be constructed in part or in whole of a single or multiple III-V alloys. The substrate 113 (and/or handle) may be constructed of a III-V alloy(s) or a substrate 113 may be constructed of a different material such as silicon or glass whose purpose is mechanical stability and/or rigidity and/or materials such as copper or diamond whose purpose is thermal extraction.

The emitter 120 and PV cell 114 should have mutually compatible physical properties in order to maximize the electrical power density produced by the PV cell 114 and/or the energy conversion efficiency of the TPV device 100. The bandgap energy, E_{g}, of the active region of the PV cell 114, which defines the photon energy needed for charge separation and collection, may be between 0.1 eV and 2.0 eV or between 0.2 eV and 1.5 eV. The electromagnetic radiation emitted by the emitter 120 and absorbed by the PV cell 114 (referred to as the radiative exchange) should be minimized below E_{g} to achieve high energy conversion efficiency and maximized above E_{g} to achieve high electrical power density. Alternatively, the radiative exchange may be maximized in a narrow band just above E_{g} and minimized for all other energies in order to maximize energy conversion efficiency. These objectives could be achieved by the use of a spectrally selective emitter 120 (i.e., a material or materials that preferentially emit broadly above E_{g} or in a narrow band just above E_{g}) and/or by the use of a spectrally selective PV cell 114 (i.e., a cell that preferentially absorbs broadly above E_{g} or in a narrow band just above E_{g}). To maximize the radiative exchange broadly above E_{g} or in a narrow band just above E_{g}, multiple approaches may be used including:
(1) maximizing the propagating modes of radiative exchange present in far-field TPV configurations and near-field TPV configurations,
(2) maximizing frustrated modes of radiative exchange present only in near-field TPV configurations, and/or
(3) maximizing surface modes of radiative exchange present only in near-field TPV configurations.

Frustrated modes are modes that in the far field would be confined to the emitter by total internal reflection of photons incident from the platform 125 on the surface 127 at angles greater than the critical angle, but in the near field can tunnel to the PV cell 114. Surface modes include surface phonon polaritons and surface plasmon polaritons and are hybridized light and charge oscillation modes at a material surface which can transfer significant amounts of energy from the emitter 120 to the PV cell 114 in the near-field. For these approaches, (1) (from the list above) is achieved with the use of a highly emitting (emissivity near unity) emitter 120 and a highly absorbing (absorptivity near unity) PV cell. (2) is achieved by maximizing the tunneling of photons incident from the platform 125 on the surface 127 of the emitter 120 at angles greater than the critical angle (associated with total internal reflection) through the space 140 and into the PV cell 114. (2) benefits from matched or very similar and from high indices of refraction of the platform 125 and the PV cell 114. For III-V alloys and other semiconductors, the index of refraction is often approximately 3.5. (2) also benefits from as small a space 140 as possible. (3) is achieved by using materials for the platform 125 and PV cell 114 which support surface polariton modes, including surface plasmon polaritons (materials include highly doped semiconductors) and surface phonon polaritons (materials include polar materials such as polar dielectrics like SiO₂ or many III-V alloys). For high electrical power density and/or high energy conversion efficiency, these modes must be at energies greater than E_{g}. In all cases, it is desirable to minimize the radiative exchange below E_{g}.

In some embodiments of the present disclosure, and as shown herein, metal organic vapor-phase epitaxy (MOVPE) techniques may be used to create both a block 110 and an emitter 120 for a TPV device 100, where the emitter 120 may be selectively etched to define the space 140 between the emitter 120 and the PV cell 114. In some embodiments of the present disclosure, a PV cell 114 may be an upright double-heterostructure InAs (E_{g}≈0.35 eV at room temperature) design. The choice of a low bandgap (0.1 eV to 1.0 eV) material helps to facilitate electricity generation at lower temperatures below approximately 1,200° C.

Referring again to FIG. 1A, a TPV device 100 may collect current through the use of a front contact and a back contact. A front contact is shown in FIG. 1A as a grid 160, positioned on the surface 127 of the PV cell 114, where a grid-like design, among other things, is designed to minimize “shading” of the underlying PV cell 114. (A back contact is not shown.) A grid 160 may be formed by a plurality of grid fingers (not shown), where each grid finger is essentially a strip, a wire, and/or a circular geometry constructed of at least one conductive material, e.g., one or more metals and/or metal oxides, positioned substantially parallel to the other grid fingers. In some embodiments of the present disclosure, a grid 160 may be constructed using to sets of grid fingers, such the first set of grid fingers are substantially parallel to one another and the second set of grid fingers are also parallel to one another but are positioned substantially orthogonal and/or skewed to the alignment of the first set of grid fingers. In some embodiments of the present disclosure, a grid 160 may be constructed using a single set of grid fingers having between 1 and 100 grid fingers. In some embodiments of the present disclosure, a grid 160 may be constructed using a first set of grid fingers having between 1 and 100 grid fingers and a second set of grid fingers having between 1 and 100 grid fingers. A grid 160 may be constructed using one or more conductive metals, including, for example, at least one of platinum, palladium, gold, silver, germanium, nickel, aluminum, copper. A grid 160 may be constructed using a combination of metals such as nickel and gold, or such as palladium, germanium and/or silver. Two or more metals may be used to construct a grid 160 in order to form an ohmic contact. In some embodiments of the present disclosure, a grid 160 may be constructed using a conductive metal oxide and/or a dielectric material, transparent and/or opaque.

In some embodiments of the present disclosure, a grid finger may have a width (in the x-axis direction) between 0.5 μm and 200 μm or between 1 μm and 100 μm or between 5 μm and 20 μm. In some embodiments of the present disclosure, a grid finger may have a depth (in the z-axis direction) that is substantially equal to the depth of the PV cell 114. In some embodiments of the present disclosure, a grid finger may have a height (in the y-axis direction) between 10 nm and 15 μm or between 10 nm and 1.5 μm or between 50 nm and 150 nm. In general, a grid 160 may be designed such that all of a PV cell's surface area 115 can efficiently collect charge with minimal shading. In some embodiments of the present disclosure, less than 30% of the surface 115 of a PV cell 114 may be shaded by a grid 160, or less than 20%, or less than 5%.

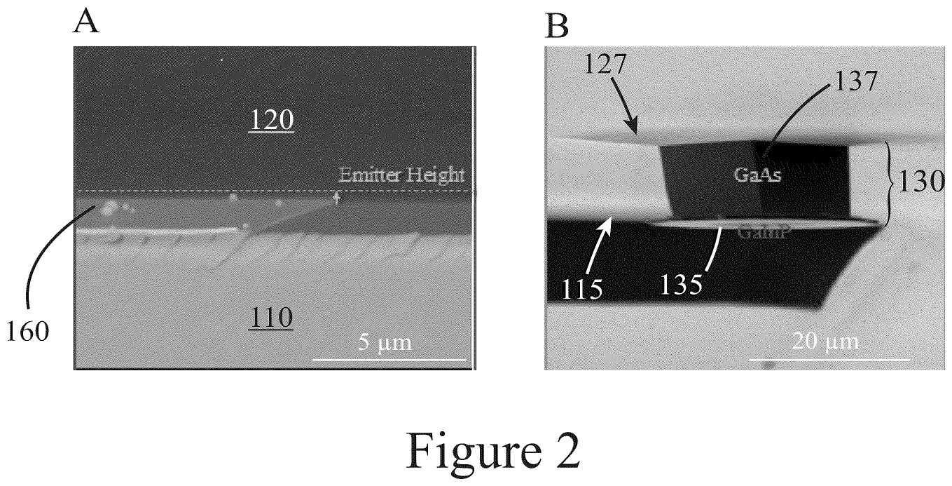

Rather than using a grid 160 having a structure consisting of narrow, tall grids (width (x) between 0.5 μm and 20 μm and height between 1-15 μm) 160, some embodiments of the present disclosure may use thin, wide grids (width>20 μm, height<1 μm) 160, as shown in Panel A of FIG. 2. To minimize or prevent the conduction of heat from the emitter 120 to the block 110, through a grid 160, a grid may be configured to have a height that is less than the space 140 between the block 110 and the PV cell 114.

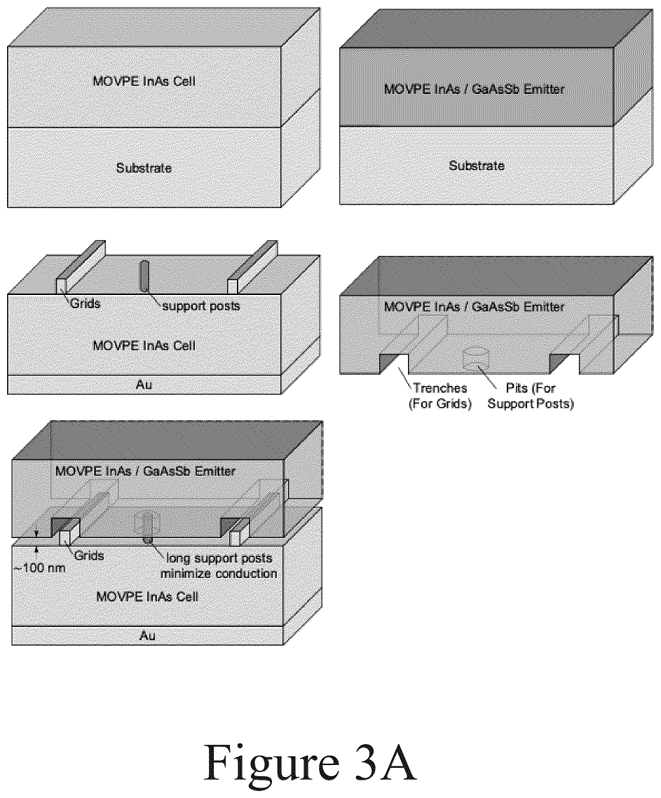

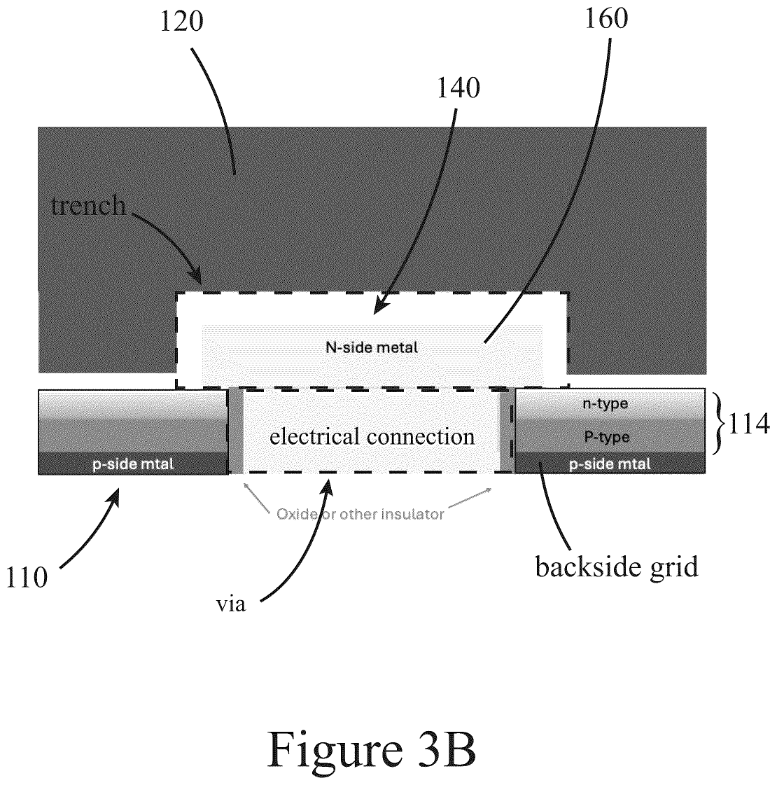

Referring to FIG. 3A, another way to eliminate and/or minimize physical contact of a grid 160 with an emitter 120 may be positioning a grid 160 within trenches, e.g., recessed spaces, intentionally formed into the surface 115 of the PV cell 114. Among other things, a benefit of recessing a grid 160 and/or the grid fingers making up a grid, into the surface of an emitter is that it enables the use of tall narrow grid fingers, which reduces shadowing. The potential benefit of pairing this with a via based contact is that doing so eliminates the need to otherwise “wire out” the front electrode, which may otherwise be challenging and/or require an area of the PV cell be intentionally not covered by the emitter to enable a wire bond and/or some other wiring. FIG. 3B illustrates a portion of an emitter 120 and block 110 where the block has a via (e.g., hole) formed through the thickness of the block, where the inner circumference of the via is coated with an insulating material (e.g., oxide or other insulator) and the remainder is filled with an a material that provides an electrical connection for the front side grid 160 through the via.

Panel A of FIG. 2 shows an SEM image of a portion of a TPV device 100 with a grid 160, where each grid finger is approximately 100 nm high and 100 μm wide. The nominal emitter 120 height is 150 nm and is marked, which leaves 50 nm between the top of the grid finger and the emitter surface 127. Note that unwanted, round metallic particles on top of the grid 160, visible in Panel A of FIG. 2, demonstrate one of the major challenges with large area devices: cleanliness throughout the process. Nevertheless, while these wide, flat grids 160 increase shadowing, e.g., reduce the surface area of the PV cell 114 available for heat transfer, on the device 100, they case assembly and packaging requirements in an already complex system by eliminating the need for fine-scale alignment. In this example, an electron beam-deposited grid 160 constructed of a nickel/gold stack was utilized, however, lower cost metallization pathways (e.g., electroplated silver) may also be used.

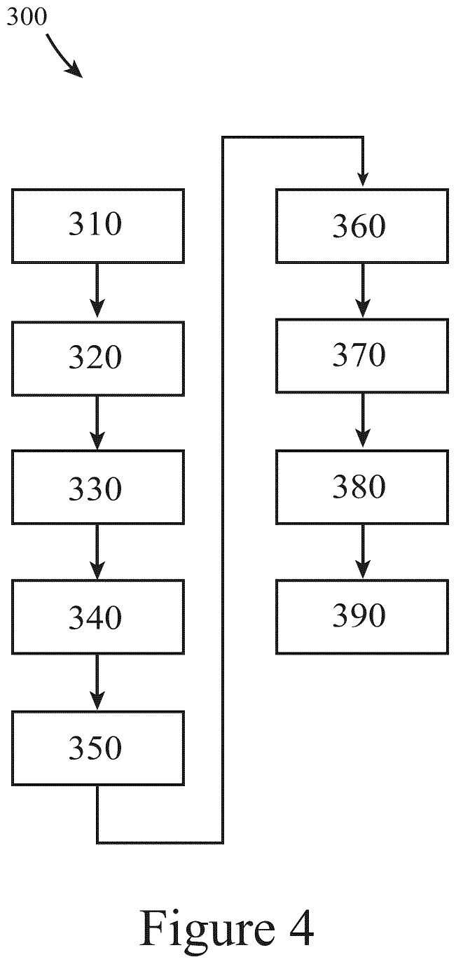

An exemplary emitter 120 was constructed of patterned GaInP on doped GaAs, where the GaInP was selectively removed everywhere other than the four tabs 135 on the four columns 137 making up the four posts 130. The GaInP had a nominal composition of Ga_{0.51}In_{0.49}P with the same lattice-constant as GaAs. Because GaInP and GaAs can be wet etched (i.e., removed) with extremely high selectivity relative to one another, with the GaAs preferentially removed, long (length between 5 μm and 100 μm), narrow (cross sectional area between 5 and 500 μm²) posts 130 were produced using a method as shown in FIG. 4, with an SEM image of the resultant exemplary post 130 illustrated in Panel B of FIG. 2. As described above, the posts 130 separate the emitter 120 and block 110, and the thickness of the remaining tabs 135 of GaInP defines the space 140 between the GaAs emitter 120 and the InAs block 110. GaAs and InAs have similar refractive indices near the InAs bandgap, which helps facilitate near-field heat transfer by frustrated modes between the two components of the TPV device 100. Thus, by using epitaxy in combination with selective wet etching processes, emitter structures were created with a highly controllable space 140 between the opposing surfaces (127 and 115) of the emitter 120 and the PV cell 114, respectively, defined by the thickness of the lattice-matched GaInP tabs 135. As thermal conductance scales proportionally to area and inversely proportionally to length, creating long and narrow posts serves to reduce losses due to parasitic conduction.

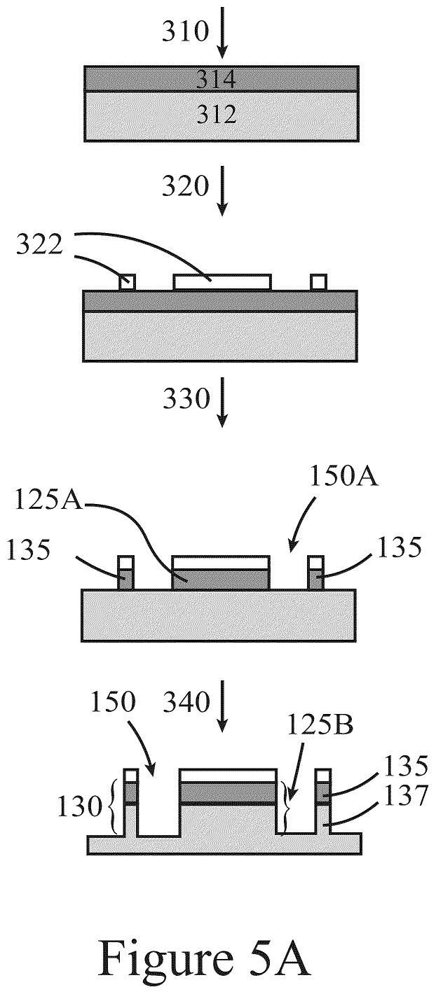

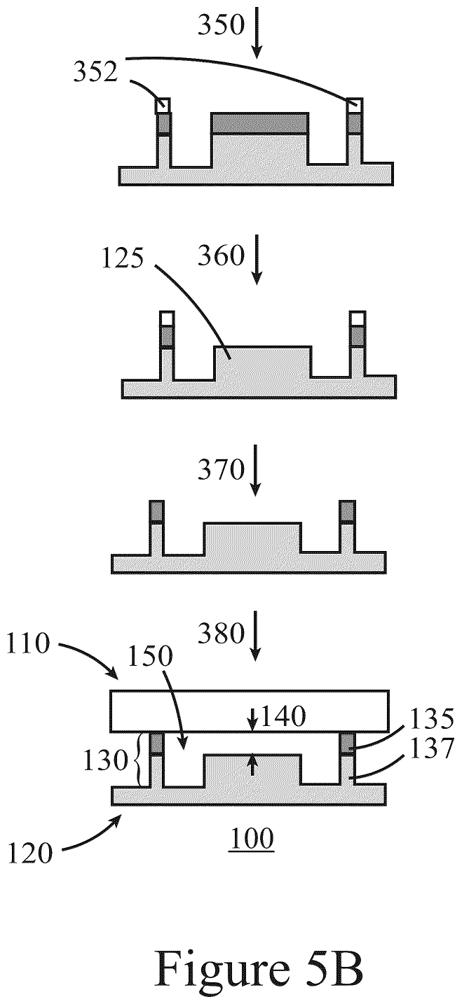

FIG. 4 illustrates an exemplary method 300 for producing TPV devices 100, like those described above. FIGS. 5A and 5B illustrate the progression of intermediate devices resulting from each method step illustrated in FIG. 4, concluding with the final targeted TPV device 100. Referring to FIG. 4, the method 300 illustrated is directed primarily to the manufacturing of an emitter 120 of a TPV device 100, more specifically, manufacturing steps for producing the posts 130, the platform 125, and the gaps 150 positioned between the posts 130 and the platform 125. Also of importance, is producing a consistently smooth surface 127 on the platform 125 to insure a consistent narrow space 140 is created when the emitter 120 is combined with the block 110.

Thus, referring again to FIG. 4, the exemplary method 300 illustrated may begin with creating 310 a conformal layer of precise depth 314 onto a base layer 312 (see FIG. 5A). As will be shown below, the conformal layer 314 provides the material (e.g., GaInP) that eventually becomes the tabs 130 of the posts 130, whereas the base layer 312 provides the material that will eventually become the columns 137 of the posts 130, as well as the platform 125 of the emitter 120. For these reasons, the base layer 312 should be constructed of a material having the desired physical properties (e.g., emissivity, refractive index, etc.) that will enable the platform 125 to emit the proper wavelength(s) of light at the desired target operating temperature of the emitter 120. Further, the base layer 312 should provide a surface that enables the depositing 310 of a high quality layer having a smooth conformal surface and well defined depth; e.g., the conformal layer 314 (e.g., of GaAs). In addition, the thickness of the conformal layer 314 deposited onto the base layer should be approximately equal to final desired space 140 eventually created when the emitter 120 is combined with the block 110.

In some embodiments of the present disclosure, the depositing 310 of a conformal layer 314 onto a base layer 312 may be achieved by a deposition process such as Metal-Organic Chemical Vapor Deposition (MOCVD, also known as Metal-Organic Vapor Phase Epitaxy, MOVPE). Other epitaxial deposition methods such as Molecular Beam Epitaxy (MBE) or Hydride Vapor Phase Epitaxy (HVPE) could be used. Other non-epitaxial deposition methods such as electron-beam evaporation, atomic layer deposition, or sputtering could be used, insofar as they can deposit a conformal layer 314 with precise thickness onto a base layer 312. Ion implantation could also be used to create a conformal layer 314 with different electrical characteristics from the base layer 314, such that a selective etchant could remove only the conformal layer 314.

Referring again to FIG. 4, once a conformal layer 314 has been deposited onto a base layer 312, a method 300 may proceed with the depositing 320 of a mask 322 (see FIG. 5A) onto the surface of the conformal layer 314. This mask 322, the first of two masks used in the method 300, defines which surfaces will be etched and corresponding underlying mass removed to eventually form the posts 130 and the platform 125 of the emitter 120. This first mask may be deposited using standard lithographic processes such as photolithography or electron beam lithography, using either a resist-based soft mask or using photoresist to define a hard mask composed of any number of standard materials including oxides, nitrides, and/or metals. These masks could alternatively be hard shadow masks (for example, patterns removed from a thin sheet of metal or other material) instead of using a lithography-based process.

With the first mask 322 deposited onto the conformal layer 314, the method 300 may proceed with a first removing 330 of the portions of the conformal layer 314 not protected by the first mask 322. As a result of the first removing 330, the tabs 135 are formed, as defined by an intermediate gap 150A and an intermediate platform 125A (see FIG. 5A). The tabs 135 may have thicknesses about equal to the starting thickness of the conformal layer 314. In some embodiments of the present disclosure, a first removing 330 of portions of the conformal layer 314 may be achieved using a chemical etchant. By using a chemical etchant that selectively etches the material used to construct the conformal layer 314 (e.g., GaInP) and not the material of the underlying base layer 312 (e.g., GaAs), essentially the entire thickness of the conformal layer 314 may be removed for those portions of the conformal layer 314 that are not protected by the mask 322.

For the example of GaInP off GaAs, mixtures of hydrochloric acid and phosphoric acid or simply hydrochloric acid will selectively remove GaInP from GaAs. The etch time will depend on the ratio of HCl in the mixture and the layer thickness, with the etch time decreasing with increasing HCl content and increasing with increasing layer thickness. For a 1:5 volumetric mixture of fuming HCl and 85% strength phosphoric acid a 150 nm layer is etched in approximately 5 minutes at room temperature. For certain combinations of conformal layer 314 and base layer 312, dry etching using ionized gas mixtures may be preferable. A non-selective wet or dry etchant could also be used to combine steps 330 and 340. The posts could also be defined using laser ablation, assuming effective particle generation control measures.

Complete posts 130, having both tabs 135 and columns 137 may be subsequently formed in a second removing 340 step where portions of the base layer 312 are selectively removed to complete the gaps 150 (see FIG. 5A). In some embodiments of the present disclosure, a second removing 350 of portions of the base layer 312 may be achieved using a chemical etchant. By using a chemical etchant that selectively etches the material used to construct the base layer 312 (e.g., GaAs) and not the material of the tabs 135 (e.g., GaInP), a specific portion of the base layer 312 may be removed for those portions of the base layer 312 that are not protected by the mask 322. After completing the second removing 340 step, an intermediate platform 125 remains, constructed of both material remaining from the conformal layer 314 and material from the base layer 312.

A method 300 may then proceed with the removing of the first mask (not shown in FIG. 4) so that the method may continue with the depositing 350 of a second mask 352 to the surface of the tabs 135 of the posts 130. This second mask 352 is deposited to enable the selective removal of the material remaining from the earlier deposited conformal layer 314 to form a platform 125 that is essentially entirely constructed of the starting base layer 312 (see FIG. 5B). A mask may be removed using any suitable and compatible etchant; for example acetone may be used to remove a mask made of a positive resist; HF may be used if an SiO₂ hard mask is used. Once the second mask 252 has been deposited onto the posts 130, the method 300 may proceed with a removing 360 step, where any remaining material from the conformal layer 314 is removed from the platform 125. This removing 360 step may also deepen the gaps 150 between the posts 130 and the platform 125 (see FIG. 5B). In some embodiments of the present disclosure, laser ablation may be utilized to form at least a portion of the gaps 150 between posts 130.

Referring again to FIG. 4, a method 300 may conclude with a final removing 370 step, where any remaining mask, first mask 322 and/or second mask 352 are removed from the emitter 120. Depending on the mask type used, the removal can be done using a wet chemical (e.g., acetone, HF, etc.) or a plasma treatment such as a UV ozone. These steps may also both bc performed. Additional cleaning steps such as sonication and/or an RCA clean may be used depending on the compatibility of the emitter materials with those processes. Once these final steps are completed, the final complete TPV device 100 may be created by the positioning 380 of a block 110 onto the emitter 120. In some embodiments of the present disclosure, for designs requiring precise alignment, tools such as wafer bonders and/or flip chip bonders may be used.

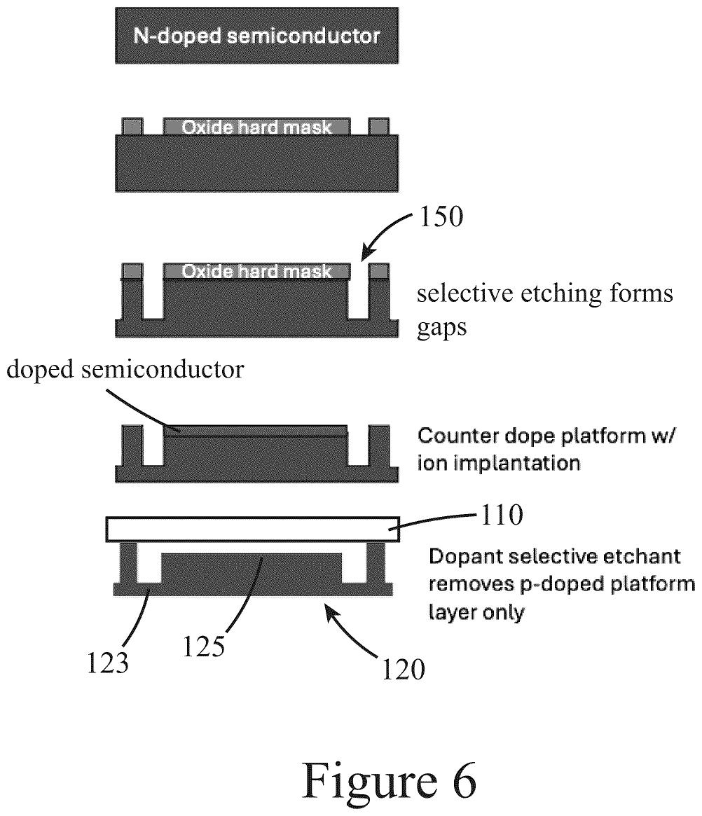

Although the methods described above for manufacturing an emitter 120 focus on depositing a second material that will eventually become the tabs 135 of the posts 130 onto a first material that will eventually become the platform 125 and base 123 of the emitter, via targeted selective etching, other methods may be used that do not necessarily need a depositing 310 step. For example, referring to FIG. 6, an emitter 120 may be produced by depositing a hard oxide mask onto a layer of the material that will be used to make the platform 125 and the base 123 of the emitter 120. This hard oxide mask may be patterned so that the gaps 150 between the platform 125 and the posts 130 may be formed in a subsequent selective etching step. Next, with the gaps 150 formed, instead of depositing a layer that will result in the tabs 135, the top surface of the starting material may be treated by ion implantation, resulting in a top portion of the starting semiconducting material being transformed into a doped semiconductor; e.g., p-doped or n-doped. Then, through the use of a selective etchant, the doped layer may be selectively removed in a subsequent step to form what will become the space 140 when the emitter 120 is combined with the block 110 to form the complete TPV device 100. So, in this embodiment a post 130 only includes a column 137; there is no separate and distinct tab 134 constructed of a different alloy.

In still other embodiments, a top surface of the material used to form an emitter 120 may be partially damaged using, for example, laser ablation such that the damaged portion is more susceptible to chemical etching, such that a TPV device like that illustrated in FIG. 6 may be constructed; e.g., with posts 130 lacking tabs 135.

### Experimental:

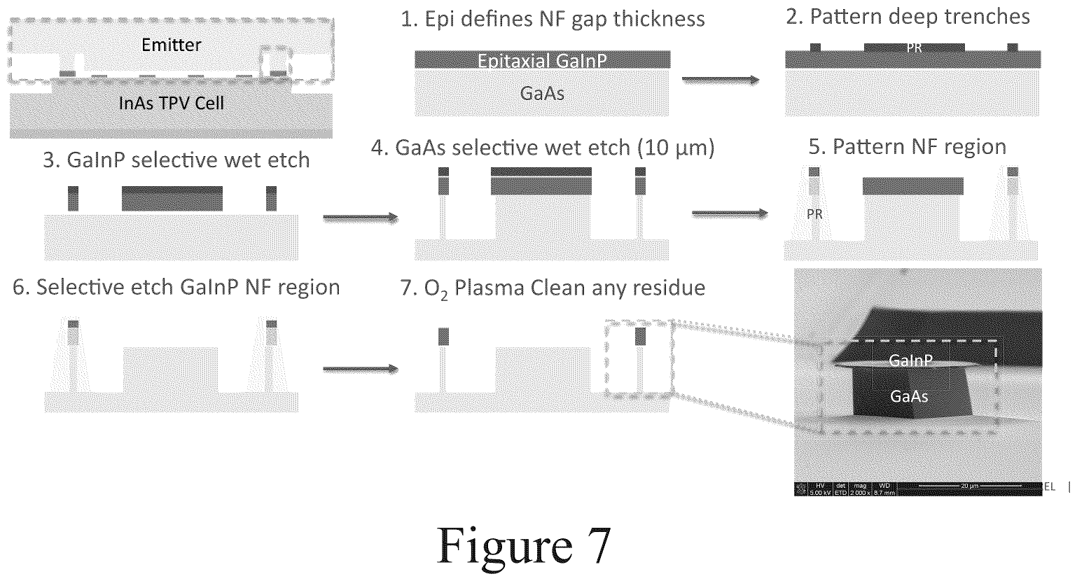

FIG. 7 illustrates a schematic of a specific method used to construct the emitter of a TPV device, according to some embodiments of the present disclosure. The method illustrated is essentially the same as the method illustrated in FIGS. 4, 5A, and 5B, but with additional specifics illustrated.

1. Grew nominally 500 nm (with possible ranges between 10 nm and 1 μm) thick conformal layer of nominally Ga_{0.51}In_{0.49}P (GaInP) on a GaAs substrate using MOCVD to define gap thickness.

2. Photolithography was used to define the posts and near-field region. Additional lithographic methods (nanoimprint, EBL, etc.) could also be used for both lithography steps. Material around supporting posts must be removed to ensure these have relatively small lateral dimensions of 1-50 μm. Regions may also be defined in this step that will align to gridlines or other surface features on the corresponding other half of the nanogap device. This step could be done with either wet or dry etching.

3. Used a 1:10 hydrochloric acid (HCl): phosphoric acid (H₃PO₄) mixture to selectively etch the GaInP layer.

4. Used a 2:1:10 ammonium hydroxide: hydrogen peroxide: water mixture to selectively etch 10 μm or more into the underlying GaAs layer, creating thin, tall posts and tall near-field platforms. Note that this could be a wet chemical etch or a dry etch, the latter of which might also require the deposition of an additional hard masking layer such as SiO₂ between steps 1 and 2.

5. Used photolithography to protect the posts. This could be done using the photoresist itself or a different protective layer (hard masking material).

6. Used a 1:10 HCl: H₃PO₄ mixture to remove the GaInP from the near-field mesa areas. Note that by etching the near-field region, we also remove particles from the near-field region which could otherwise interfere with the assembly, another challenge of these types of devices. This could again be done using wet or dry etching.

7. Used an oxygen plasma clean to remove any residual photoresist or other organic residue introduced during processing.

8. Placed the completed sample on the photovoltaic cell or other partner material. This step may require the use of alignment tools such as a flip-chip bonder if there are features such as tall front metal grids that should align with places where material has been removed.

9. If desired, an appropriate bonding agent may be introduced between the posts and the partner material to ensure a secure completed device.

Using this method of manufacture, a TPV device was made that demonstrated a measure power output of 1.22 mW at an emitter temperature of 460° C. and a block nominal temperature of about −10° C. with a nominal space between emitter and block of 150 nm, several orders of magnitude higher than previous reports near 500° C. Further, this device having a nominal platform surface area of about 0.28 cm² device has the potential to be scaled towards larger sizes through increased device area or by tiling devices into a module.

For this exemplary TPV device, both the TPV cell and emitter were grown using metal organic vapor phase epitaxy (MOVPE). The GaAs emitter and InAs cell were designed to complement each other and were co-fabricated to ensure easy assembly. InAs and GaAs have similar refractive indices in the mid-IR, facilitating evanescent coupling of frustrated modes between the hot emitter and cool cell.

For this exemplary device, the emitter was constructed of a lattice-matched nominal 150 nm GaInP tab grown on an n+GaAs base. The GaInP tab was selectively wet etched everywhere except for the locations of the four supporting posts, which resulted in the GaInP tab thickness defining the size of the nanoscale space. The underlying GaAs base was deeply chemically etched around the four posts, forming gaps, ensuring a relatively long conduction path from the emitter to the cell (i.e., block) through the posts. The emitter posts had a cross-sectional area of approximately 250 μm² and a height of approximately 10-15 μm to reduce parasitic conduction to the cell. For this geometry, assuming a cell temperature of 20° C. and an emitter temperature of 500° C., one may expect that approximately 9% of the total heat transfer to the cell may occur through conduction.

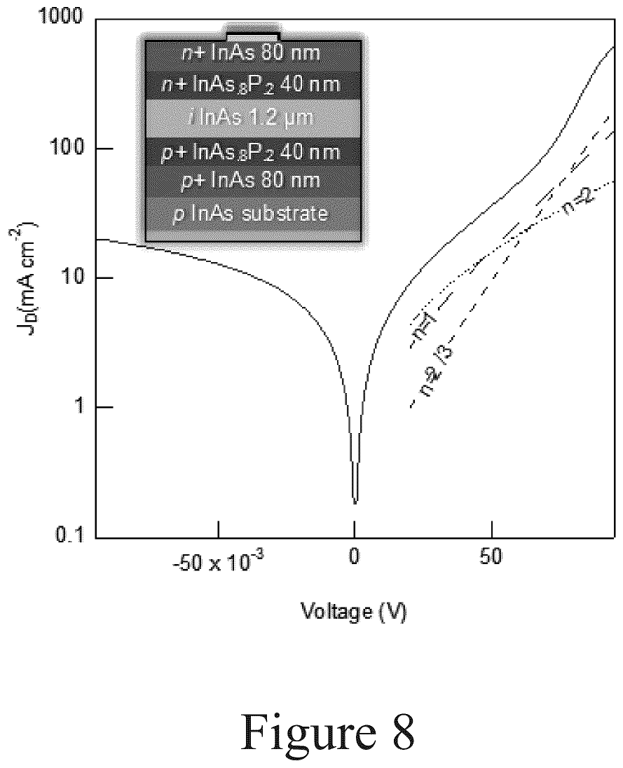

InAs has a bandgap of approximately 0.35 eV near room temperature and so is an appropriate cell material for low temperature sources. An n-i-p double heterostructure was used for the PV cell (see inset of FIG. 8) to minimize auger recombination, a key limiting factor in low bandgap devices and high current devices. The PV cell front electrode was designed with short wide grid fingers (0.1 μm×100 μm) with a grid pitch of 400 μm in order to lay directly beneath the emitter without the need for complex alignment or bonding equipment. FIG. 8 illustrates the current density as a function of voltage for the TPV device used in this study at a nominal temperature of 10° C. measured in the dark. The TPV device demonstrated a reverse bias saturation current of approximately 20 mA cm⁻².

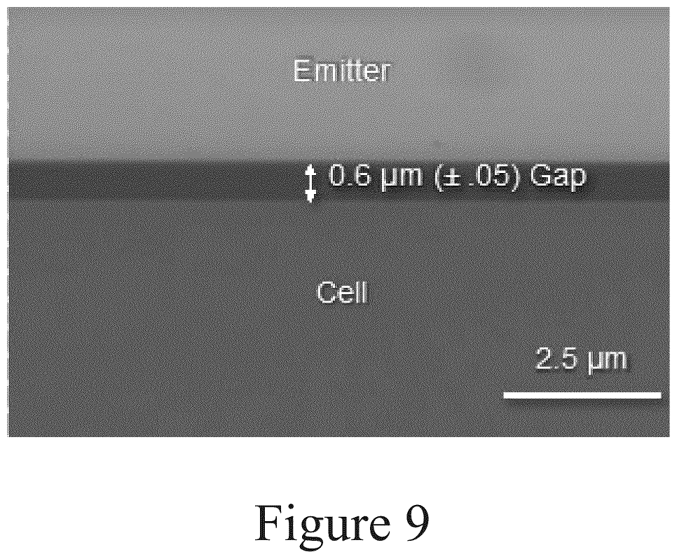

Following the fabrication of both emitter and cell (i.e., block), the emitter was placed directly on the PV cell of the block in a clean environment to avoid particulates. FIG. 9 illustrates an SEM image of the nano-scale space created using a nominal 500 nm GaInP tab. This sample shows a gap size of 600 (±50) nm. The SEM imaging details are available in the experimental methods.

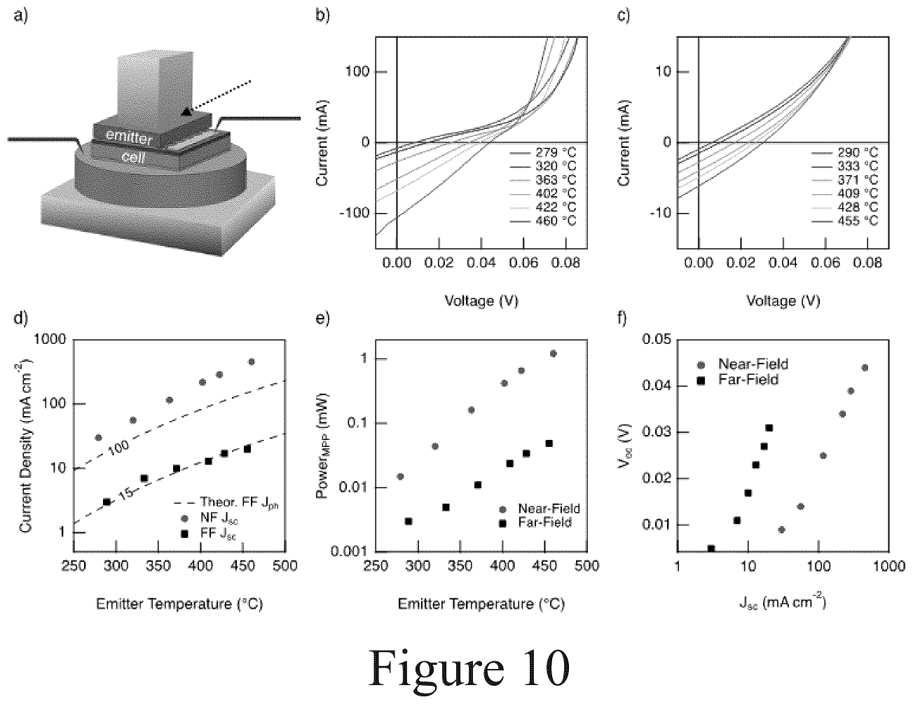

To evaluate near-field devices, a custom thermally illuminated current voltage measurement facility was designed. As shown in Panel a of FIG. 10, the heat source was in physical contact with the emitter to ensure good conductive heat transfer between the two. The emitter temperature was measured at the indicated thermocouple position. The block sat on a copper post mounted to a water-cooled plate to dissipate heat from the block.

For electrical characterization, a near-field emitter with a nominal 150 nm space was used. To facilitate a direct comparison to a far-field emitter, a second emitter with an approximate 10-15 μm space was fabricated in the same manner as was used to fabricate the near-field emitter. For testing, the far-field emitter was positioned on the same cell, which eliminated cell to cell variation as a factor in the current-voltage characteristics. Due to the proximity of the emitter to the block in both the near-field and far-field cases, a full emitter area of 0.28 cm² was used in the near field case and 0.35 cm² in the far-field case (including the front metallization) as the active area when calculating the current density and assumed a view factor of 1.

The experimental near field thermophotovoltaic (NFTPV) device demonstrated a significant increase in the short circuit current, and thus the generated power, as compared to the far-field. A very significant increase in the short circuit current was observed in the near-field case as compared to the far-field case (see Panels b-d of FIG. 10). Comparing the cell at the two highest emitter temperatures, 460° C. and 455° C. in the near- and far-fields respectively, the difference in short circuit current is greater than an order of magnitude. The near-field and far-field JV curves have a different shape. In the near-field case, a nearly linear behavior in the power quadrant was observed. This linear behavior can be predominantly attributed to a series resistance and increased cell temperature in the near-field case.

To verify the impact of near-field radiative heat transfer mechanisms on the observed variation in the electrical behavior, the measured short circuit current density in the near- and far-field cases with modeled far-field photocurrents were compared (see Panel d of FIG. 10). In standard photovoltaics J_{sc} ≅Jₚₕ however, based on the IV curve shape in our near-field case, one may expect J_{sc} <Jₚₕ due to the impact of series resistance at high optical flux densities. Nevertheless, despite the non-standard diode behavior exhibited by the tested device, J_{sc,NF}>J_{ph,FF} by a significant margin even when assuming an internal quantum efficiency (IQE) of 100%. The far-field data better fits an IQE of 15% than 100%, although the true IQE of this device is not known. In the near-field case, exponential growth was observed in the both the short circuit current density, Panel d of FIG. 10, and the peak power, Panel e of FIG. 10, with increasing emitter temperature. The peak power is 1.22 mW at 460° C. in the near-field case and 0.05 mW at 455° C. in the far-field case. The open circuit voltage increased less for NF compared to FF, as a function of short circuit current density (see Panel f of FIG. 10). The NFTPV results represent a high total output power using emitter temperatures at or below 800° C. In addition, the near-field configuration leads to .04 mW of output power at 320° C., comparable in magnitude to the .05 mW measured at 455° C. in the far-field case, emphasizing NFTPV's unique suitability for low temperature heat sources.

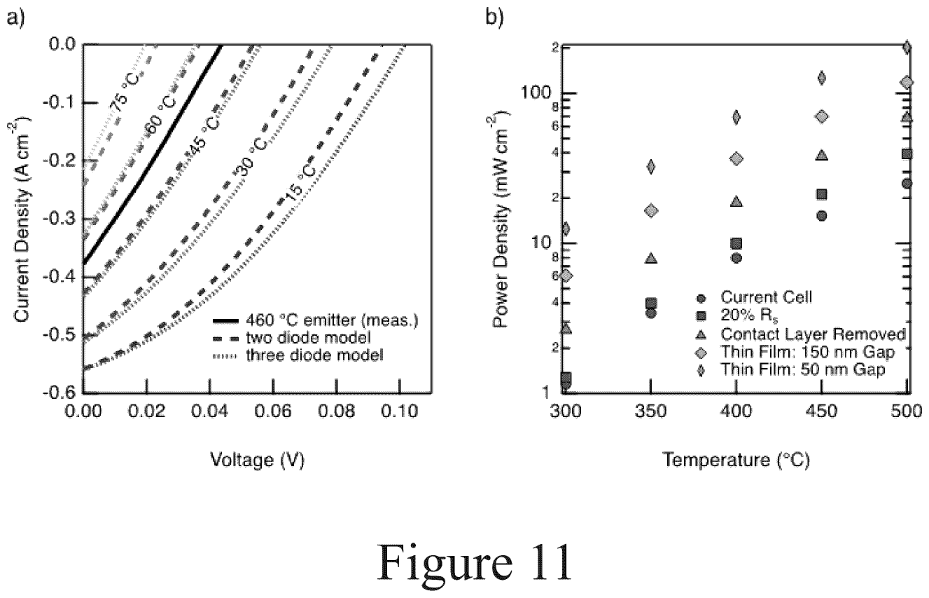

There are several possible areas for system level and device level design improvements, which are described below. As shown in Panel f of FIG. 10, suggesting possible cell heating the impact of cell temperature should be considered (see Panel a of FIG. 11). The NFTPV device was modeled using both a standard two-diode model, and a three diode model, including Auger recombination. For the three-diode model, the Auger dark current varies with temperature according to the following equation:

$${J}_{0 , a u g} = {C}_{1} {T}^{4.5} exp ( \frac{- {E}_{g}}{2 / 3 {k}_{b} T} )$$

where T is the cell temperature in K, E_{g} is the temperature dependent bandgap in eV, kg is the Boltzmann constant in eV/K, and C₁ is a proportionality constant. For the three-diode model, we extract the proportionality constants for J_{0,1}, J_{0,2}, and J_{0,aug} from the dark J-V measurement for this device (see FIG. 8). As cell temperature increases, the open circuit voltage and the short circuit current densities decrease. The reduction in both open circuit voltage and short circuit current density with increasing temperature can lead to a significant reduction in output power. Modeling suggests lowering the cell temperature to room temperature should result in an approximate four-fold increase in power at an emitter temperature of 460° C.

In addition to system level improvements, we expect improvements to the device itself will also yield substantial increases in power. Panel b of FIG. 11 illustrates the anticipated output power improvements from a series of cumulative cell design improvements, assuming system improvements that cool the cell to 20° C. First, the impact of reducing the estimated series resistance (65 mΩcm⁻²) by 80% is illustrated. The diode irregularities observed agree reasonably well with theoretical predictions of the effect of series resistance on NFTPV. One may expect that the series resistance arises due to the wide, flat front electrode geometry and insufficient electrical contact between the back contact and the stage. The latter issue may be resolved by packaging improvements (i.e., solder bonding the cell to a patterned thermally conductive chip). In the case of the former, counter sinking our front electrodes into our emitter would both reduce shadowing and allow for concentrator cell grid geometries optimized for the expected optical flux at 500° C.

Removing the highly doped n+InAs contact layer should have two beneficial effects: 1) the photocurrent will increase by eliminating parasitic band-to-band and free carrier absorption 2) a the IQE to improve in this case, regardless of the photocurrent. The heavily doped contact layer may currently serve as a potent source of auger recombination. Here, one may assume an improved IQE of 75% following contact layer removal in line with prior modeling.

Finally, power could be further increased by using a thin film geometry with a highly reflective Au back reflector, which could be obtained by removing the cell from the substrate via chemical etching or epitaxial liftoff. This case was modeled for a nominal gap size (150 nm) and one for a 50 nm gap size. A thin film geometry may result in a significant increase in photocurrent, because light will pass multiple times through the intrinsic region as it bounces between the reflector and the surface, as well as a significant reduction in sub-bandgap absorption. In a thin-film geometry with a highly effective back reflector, most of the sub-bandgap light is reflected back to the emitter itself rather than being absorbed and heating the cell. As such, the reduction in sub-bandgap absorption associated with this geometry should also lessen cooling requirements at a given cell temperature. Near-field offers a unique opportunity to improve cell output power simply by reducing gap size. A 50 nm gap size may further increase the photocurrent by enhancing the evanescent coupling effects between the emitter and the cell leading to an anticipated power density in excess of 200 mW cm⁻² at 500° C.

### EXAMPLES

Example 1. A thermophotovoltaic (TPV) device comprising: an emitter comprising a platform and a base; a block comprising a photovoltaic (PV) cell; and three posts, wherein: the platform comprises a first surface having a first surface area between 0.1 cm² and 1,000 cm², the PV cell comprises a second surface having a second surface area between 0.1 cm² and 1,000 cm², the posts separate the first surface from the second surface by a space in the y-axis direction between 1 nm and 1,000 nm, each post is paired with a gap that separates the post from the platform, each gap is between 0.5 μm and 500 μm in the x-axis direction, and the TPV device is capable of converting at least one of near-infrared light or mid-infrared light to electricity.

Example 2. The TPV device of Example 1, wherein the first surface area is between 1 cm² and 100 cm

Example 3. The TPV device of either Example 1 or Example 2, wherein the second surface area is between 1 cm² and 100 cm.

Example 4. The TPV device of any one of Examples 1-3, wherein the space is between 10 nm and 200 nm or between 50 nm and 100 nm.

Example 5. The TPV device of any one of Examples 1-5, wherein each gap is between 1 μm and 250 μm or between 1 μm and 100 μm.

Example 6. The TPV device of any one of Examples 1-6, having exactly three posts positioned in a triangular configuration.

Example 7. The TPV device of any one of Examples 1-7, having exactly four posts positioned in either a square configuration or a rectangular configuration.

Example 8. The TPV of any one of Examples 1-8, comprising an n×n array of posts, wherein n is between 2 and 10, inclusively.

Example 9. The TPV device of any one of Examples 1-8, wherein each post has a height in the y-axis direction between 1 μm and 100 μm or between 10 μm and 50 μm.

Example 10. The TPV device of any one of Examples 1-9, wherein each post has a length dimension in the x-axis direction between 1 μm and 250 μm or between 10 μm and 100 μm.

Example 11. The TPV device of any one of Examples 1-10, wherein: each post comprises a column and tab, each column is positioned between tab and the base, and the tab has thickness in the y-axis direction that is about equal to the space.

Example 12. The TPV device of any one of Examples 1-11, wherein the emitter is configured to operate at a first temperature between 100° C. and 2500° C.

Example 13. The TPV device of any one of Examples 1-12, wherein the first temperature is between 200° C. and 600° C.

Example 14. The TPV device of any one of Examples 1-13, wherein the block is configured to operate at a second temperature between −200° C. and 500° C.

Example 15. The TPV device of any one of Examples 1-14, wherein the second temperature is between 20° C. and 50° C.

Example 16. The TPV device of any one of Examples 1-15, wherein the PV cell is configured to operate at a second temperature between −200° C. and 500° C.

Example 17. The TPV device of any one of Examples 1-16, wherein the second temperature is between 20° C. and 50° C.

Example 18. The TPV device of any one of Examples 1-17, wherein the PV cell is constructed of a semiconductor having bandgap between 0.1 eV and 2.0 eV or between 0.2 eV and 1.5 eV.

Example 19. The TPV device of any one of Examples 1-18, wherein the PV cell comprises a single-junction cell, a two-junction cell, or a multi-junction cell.

Example 20. The TPV device of any one of Examples 1-19, wherein the PV cell is constructed using first III-V alloy.

Example 21. The TPV device of any one of Examples 1-20, wherein the first III-V alloy comprises InAs.

Example 22. The TPV device of any one of Examples 1-21, wherein the emitter is constructed of a second III-V alloy.

Example 23. The TPV device of any one of Examples 1-22, wherein the platform, the base, and each post are constructed of the second III-V alloy.

Example 24. The TPV device of any one of Examples 1-23, wherein the second III-V alloy comprises at least one of GaAs, InP, InAs, or GaSb.

Example 25. The TPV device of any one of Examples 1-24, wherein: the platform, the base, and each column are each constructed of a second III-V alloy, and each tab is constructed of a third III-V alloy.

Example 26. The TPV device of any one of Examples 1-25, wherein: the second III-V alloy comprises at least one of GaAs, InP, InAs, or GaSb, and the third III-V alloy comprises GaInP.

Example 27. The TPV device of any one of Examples 1-26, wherein the third III-V alloy is approximately Ga_{0.51}In_{0.49}P.

Example 28. The TPV device of any one of Examples 1-27, wherein the posts are positioned directly on the second surface.

Example 29. The TPV device of any one of Examples 1-28, wherein: the block further comprises a substrate, and the PV cell is positioned on the substrate.

Example 30. The TPV device of any one of Examples 1-29, wherein the posts are positioned directly on the substrate.

Example 31. The TPV device of any one of Examples 1-30, further comprising:
a front contact comprising a grid positioned on the second surface of the PV cell, wherein: the grid is positioned in the space without physically touching the first surface of the emitter.

Example 32. The TPV device of any one of Examples 1-31, wherein: the grid comprises a first plurality of fingers, and each finger is oriented substantially parallel to the other fingers.

Example 33. The TPV device of any one of Examples 1-32, wherein: the grid further comprises a second plurality of fingers, each finger of the second plurality of fingers is oriented substantially parallel to the other fingers of the second plurality of fingers, and each finger of the second plurality of fingers is oriented perpendicular or askew to the first plurality of fingers.

Example 34. The TPV device of any one of Examples 1-33, wherein the grid is constructed of at least one of a metal or a conductive metal oxide.

Example 35. The TPV device of any one of Examples 1-34, further comprising: a trench formed in the first surface of the emitter, wherein: the grid is positioned within the trench such that the grid does not physically contact the first surface of the emitter.

Example 36. The TPV device of any one of Examples 1-35, further comprising: a via passing through at least one of the PV cell or the substrate, wherein: the outer circumference of the via is lined with an insulator, and the remainder of the via is at least partially filed with an electrical connection connected to the grid.

Example 37. A method for fabricating a thermophotovoltaic device, the method comprising: depositing a conformal layer having a surface and a first thickness and comprising a first III-V alloy onto a surface of a substrate having a second thickness and comprising a second III-V alloy; depositing a first mask onto a first section, a second section, and a third section of the surface of the conformal layer, resulting in three portions of the surface of the conformal layer being covered by the first mask, separated by at least two portions of the surface of the conformal layer not covered by the first mask; selectively removing the at least two portions of the conformal layer not covered by the mask, resulting in the conformal layer being divided into a platform positioned between a first tab and a second tab, with a first gap positioned between the first tab and the platform, and a second gap positioned between the second tab and the platform, where the surface of the substrate is exposed at the first gap and the second gap; selectively removing a portion of the second thickness positioned under the exposed surfaces of the substrate, resulting in the forming of a first post comprising the first tab positioned on a first column of the second III-V alloy having a third thickness, a second post comprising the second tab positioned on a second column of the second III-V alloy having the third thickness, where the platform is positioned between the first post and the second post and each of the first gap and the second gap has a depth equal to the sum of the first thickness and the third thickness; covering each of the first post and the second post with a second mask, while leaving the platform exposed; selectively removing substantially all of the first III-V alloy from the platform resulting in the platform having an exposed surface of the second III-V alloy, and each post capped with the tabs of the first III-V alloy; removing any remaining first mask, second mask, or impurities; depositing a grid onto the exposed surface of the platform, and positioning a block having a surface and comprising a third III-V alloy parallel to and adjacent to the exposed surface of the platform, resulting in a uniform space positioned between the surface of the block and the exposed surface of the platform, where the surface of the block only has direct physical contact with the tabs.

Example 38. The method of Example 37, wherein the conformal layer is deposited by an epitaxial method.

Example 39. The method of either Example 37 or Example 38, wherein the epitaxial method comprises at least one of a vapor phase epitaxial method of a liquid phase epitaxial method.

Example 40. The method of any one of Examples 37-39, wherein the vapor phase epitaxial method comprises at least one of molecular beam epitaxy (MBE), metalorganic chemical vapor deposition (MOCVD), or atomic layer deposition (ALD).

Example 41. The method of any one of Examples 37-40, wherein the first mask is applied using photolithograph.

Example 42. The method of any one of Examples 37-41, wherein the second mask is applied using photolithography.

Example 43. The method of any one of Examples 37-42, wherein the first removal is performed using a first chemical etchant.

Example 44. The method of any one of Examples 37-43, wherein the first chemical etchant comprises an acid.

Example 45. The method of any one of Examples 27-44, wherein the acid comprises hydrochloric acid and phosphoric acid.

Example 46. The method of any one of Examples 37-45, wherein the second removal is performed using a second chemical etchant.

Example 47. The method of any one of Examples 37-46, wherein the second chemical etchant comprises a hydroxide and a peroxide.

Example 48. The method of any one of Examples 37-47, wherein the hydroxide comprises ammonium hydroxide and the peroxide comprises hydrogen peroxide.

Example 49. The method of any one of Examples 37-48, wherein the third removal is performed using a third chemical etchant.

Example 50. The method of any one of Examples 37-49, wherein the third chemical etchant comprises an acid.

Example 51. The method of any one of Examples 37-50, wherein the acid comprises hydrochloric acid and phosphoric acid.

Example 52. A method for fabricating a thermophotovoltaic (TPV) device, the method comprising: depositing an oxide mask onto a first surface of a layer comprising a III-V alloy resulting in a first portion of the first surface that is masked and a second portion of the first surface that is not masked, selectively removing a some of the layer corresponding to the second portion of the first surface, resulting in the forming of a gap defined by a column and a platform comprising a second surface and a thickness, removing the oxide mask, treating the second surface of the platform using ion implantation resulting in a converting of a portion of the thickness to a doped III-V alloy, selectively removing at least a portion of the doped III-V alloy, resulting in the platform having a height in the y-axis direction that is less than a height of the column in the y-axis direction, and placing a PV cell onto the column resulting in the TPV device.

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A thermophotovoltaic (TPV) device comprising:
an emitter comprising a platform and a base;
a block comprising a photovoltaic (PV) cell; and
three posts, wherein:
the platform comprises a first surface having a first surface area between 0.1 cm² and 1,000 cm²,
the PV cell comprises a second surface having a second surface area between 0.1 cm² and 1,000 cm²,
the posts separate the first surface from the second surface by a space in the y-axis direction between 1 nm and 1,000 nm,
each post is paired with a gap that separates the post from the platform,
each gap is between 0.5 μm and 500 μm in the x-axis direction, and
the TPV device is capable of converting at least one of near-infrared light or mid-infrared light to electricity.

2. The TPV device of claim 1, wherein each post has a height in the y-axis direction between 1 μm and 100 μm.

3. The TPV device of claim 1, wherein each post has a length dimension in the x-axis direction between 1 μm and 250 μm.

4. The TPV device of claim 1, wherein:
each post comprises a column and tab,
each column is positioned between tab and the base, and
the tab has thickness in the y-axis direction that is about equal to the space.

5. The TPV device of claim 1, wherein the emitter is configured to operate at a first temperature between 100° C. and 2500° C.

6. The TPV device of claim 5, wherein the first temperature is between 200° C. and 600° C.

7. The TPV device of claim 1, wherein the block is configured to operate at a second temperature between-200° C. and 500° C.

8. The TPV device of claim 1, wherein the PV cell is constructed of a semiconductor having bandgap between 0.1 eV and 2.0 eV.

9. The TPV device of claim 1, wherein the PV cell is constructed using a first III-V alloy.

10. The TPV device of claim 9, wherein the first III-V alloy comprises InAs.

11. The TPV device of claim 1, wherein the emitter is constructed of a second III-V alloy.

12. The TPV device of claim 11, wherein the platform, the base, and each post are constructed of the second III-V alloy.

13. The TPV device of claim 11, wherein the second III-V alloy comprises at least one of GaAs, InP, InAs, or GaSb.

14. The TPV device of claim 4, wherein:
the platform, the base, and each column are each constructed of a second III-V alloy, and
each tab is constructed of a third III-V alloy.

15. The TPV device of claim 14, wherein:
the second III-V alloy comprises at least one of GaAs, InP, InAs, or GaSb, and
the third III-V alloy comprises GaInP.

16. The TPV device of claim 1, wherein the posts are positioned directly on the second surface.

17. The TPV device of claim 1, wherein:
the block further comprises a substrate, and
the PV cell is positioned on the substrate.

18. The TPV device of claim 17, wherein the posts are positioned directly on the substrate.

19. The TPV device of claim 1, further comprising:
a front contact comprising a grid positioned on the second surface of the PV cell, wherein:
the grid is positioned in the space without physically touching the first surface of the emitter.

20. The TPV device of claim 19, further comprising:
a trench formed in the first surface of the emitter, wherein:
the grid is positioned within the trench such that the grid does not physically contact the first surface of the emitter.

21. The TPV device of claim 20, further comprising:
a via passing through at least one of the PV cell or the substrate, wherein:
the outer circumference of the via is lined with an insulator, and
the remainder of the via is at least partially filed with an electrical connection connected to the grid.

22. A method for fabricating a thermophotovoltaic device, the method comprising:
depositing a conformal layer having a surface and a first thickness and comprising a first III-V alloy onto a surface of a substrate having a second thickness and comprising a second III-V alloy;
depositing a first mask onto a first section, a second section, and a third section of the surface of the conformal layer, resulting in three portions of the surface of the conformal layer being covered by the first mask, separated by at least two portions of the surface of the conformal layer not covered by the first mask;
selectively removing the at least two portions of the conformal layer not covered by the mask, resulting in the conformal layer being divided into a platform positioned between a first tab and a second tab, with a first gap positioned between the first tab and the platform, and a second gap positioned between the second tab and the platform, where the surface of the substrate is exposed at the first gap and the second gap;
selectively removing a portion of the second thickness positioned under the exposed surfaces of the substrate, resulting in the forming of a first post comprising the first tab positioned on a first column of the second III-V alloy having a third thickness, a second post comprising the second tab positioned on a second column of the second III-V alloy having the third thickness, where the platform is positioned between the first post and the second post and each of the first gap and the second gap has a depth equal to the sum of the first thickness and the third thickness;
covering each of the first post and the second post with a second mask, while leaving the platform exposed;
selectively removing substantially all of the first III-V alloy from the platform resulting in the platform having an exposed surface of the second III-V alloy, and each post capped with the tabs of the first III-V alloy;
removing any remaining first mask, second mask, or impurities;
depositing a grid onto the exposed surface of the platform, and
positioning a block having a surface and comprising a third III-V alloy parallel to and adjacent to the exposed surface of the platform, resulting in a uniform space positioned between the surface of the block and the exposed surface of the platform, where the surface of the block only has direct physical contact with the tabs.

23. A method for fabricating a thermophotovoltaic (TPV) device, the method comprising:
depositing an oxide mask onto a first surface of a layer comprising a III-V alloy resulting in a first portion of the first surface that is masked and a second portion of the first surface that is not masked;
selectively removing a some of the layer corresponding to the second portion of the first surface, resulting in the forming of a gap defined by a column and a platform comprising a second surface and a thickness;
removing the oxide mask;
treating the second surface of the platform using ion implantation resulting in a converting of a portion of the thickness to a doped III-V alloy;
selectively removing at least a portion of the doped III-V alloy, resulting in the platform having a height in the y-axis direction that is less than a height of the column in the y-axis direction; and
placing a PV cell onto the column resulting in the TPV device.
